(19) United States
(12) Patent Application Publication
(10) Pub. No.: US 2026/0088449 A1
(43) Pub. Date: Mar. 26, 2026

(54) COATING METHOD AND RESULTANT CERAMIC-MODIFIED SEPARATORS

(71) Applicant: Amtek Research International LLC, Lebanon, OR (US)

(72) Inventors: Richard W. Pekala, Corvallis, OR (US); Weston J. Wood, Lebanon, OR (US); Don Spitz, Lebanon, OR (US); Scott Butler, Lebanon, OR (US)

(21) Appl. No.: 19/109,664

(22) PCT Filed: Sep. 22, 2023
(86) PCT No.: PCT/US2023/074921

§ 371 Date: Mar. 7, 2025

Related U.S. Application Data
(60) Provisional application No. 63/376,952, filed on Sep. 23, 2022.

(51) Int. Cl. H01M 50/451; H01M 10/0525; H01M 50/403; H01M 50/417; H01M 50/434; H01M 50/457

(52) U.S. Cl. CPC H01M 50/451; H01M 50/403; H01M 50/417; H01M 50/434; H01M 50/457; H01M 10/0525

(57) ABSTRACT

The present disclosure relates to a continuous process for coating microporous polyolefin webs with a ceramic composition or slurry, followed by drying at an elevated temperature while being restrained in the transverse direction. Such webs can be used to improve the manufacturability, performance, and safety of energy storage devices such as lithium batteries.

### RELATED APPLICATIONS

This application claims priority to U.S. Provisional Patent Application No. 63/376,952, filed on Sep. 23, 2022, and titled COATING METHOD AND RESULTANT CERAMIC-MODIFIED SEPARATORS, which is incorporated herein by reference in its entirety.

### COPYRIGHT NOTICE

@ 2023 Amtek Research International LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

The present invention relates to a continuous process for coating microporous polyolefin films with a ceramic composition or slurry, followed by drying at elevated temperature while restrained in the transverse direction, trimming the damaged edges, and winding into finished rolls. The improvements being (1) the ability to overcome edge effects that lead to defects and decreased yields when using a conventional flotation oven, and (2) faster line speeds compared to stenters used in the fabric industry as a result of staggered air knives. The resultant films exhibit good in-plane dimensional stability (i.e., low shrinkage) at temperatures both above and below the melting point of the polyolefin matrix. At high temperatures (>135 C), the pores within the bulk structure of the films can begin to collapse or shut down, thereby modifying the permeability through the film with little change to the in-plane dimensions. Such films can be used to improve the manufacturability, performance, and safety of energy storage devices such as lithium batteries. Throughout this application, the term “lithium battery” refers to Li-ion and/or rechargeable Li metal based batteries.

### BACKGROUND OF THE INVENTION

Separators are an integral part of the performance, safety, and cost of lithium-ion batteries. During normal operation, the principal functions of the separator are to prevent electronic conduction (i.e., shorts or direct contact) between the anode and cathode while permitting ionic conduction via the electrolyte. For small commercial cells under abuse conditions, such as external short circuit or overcharge, the separator is required to shutdown at temperatures well below where thermal runaway can occur. Shutdown results from the collapse of pores in the separator due to melting and viscous flow of the polymer, thus slowing down or stopping ion flow between the electrodes. Nearly all Li-ion battery separators contain polyethylene as part of a single- or multi-layer construction so that shutdown begins at ˜130° C., near the melting point of polyethylene.

Separators for the lithium-ion battery market are presently manufactured via “dry” or “wet” processes. Celgard LLC and others have described a dry process in which polypropylene (PP) or polyethylene (PE) is extruded into a thin sheet and subjected to rapid drawdown. The sheet is then annealed at 10-25° C. below the polymer melting point such that crystallite size and orientation are controlled. Next, the sheet is rapidly stretched in the machine direction (MD) to achieve slit-like pores or voids. Trilayer PP/PE/PP separators produced by the dry process are commonly used in lithium-ion rechargeable batteries.

Wet process separators composed of high molecular weight polyethylene are produced by extrusion of a plasticizer/polymer mixture at elevated temperature, followed by phase separation, biaxial stretching, and extraction of the pore former (i.e., plasticizer). The resultant separators have elliptical or spherical pores with good mechanical properties in both the machine and transverse directions. PE-based separators manufactured this way by Toray, Asahi, SEM Corp, and ENTEK have found wide use in Li-ion batteries.

In the case of large format or higher capacity Li-ion cells designed for electric vehicles, the benefits of separator shutdown have been questioned because it is difficult to guarantee a sufficient rate and uniformity of shutdown throughout the complete cell. As such, many companies are focused on modifying the construction of a lithium-ion cell to include (1) a heat-resistant separator or (2) a heat-resistant layer coated on either the electrodes or a conventional polyolefin separator. Heat-resistant separators composed of high temperature polymers (e.g., polyimide) have been produced on a limited basis from solution casting, electrospinning, or other process technologies. In these cases, the high polymer melting point prevents shutdown at temperatures below 200° C.

In U.S. Pat. No. 9,896,555 B2, ENTEK described a freestanding, microporous, ultrahigh molecular weight polyethylene (UHMWPE)-based film that contained sufficient inorganic filler particles to provide low shrinkage while maintaining high porosity at temperatures above the melting point of the polymer matrix (>135° C.). Such freestanding, heat resistant films have excellent wettability and ultralow impedance, but they do not exhibit shutdown properties because of the high loading level of the inorganic filler.

In U.S. Pat. No. 7,638,230 B2, a porous heat resistant layer was coated onto the negative electrode. The heat resistant layer was composed of an inorganic filler and a polymer binder. Inorganic fillers included magnesia, titantia, zirconia, or silica. Polymer binders included polyvinylidene fluoride and a modified rubber mixture containing acrylonitrile units. The heat resistant layer included 1-5 parts binder for every 100 parts inorganic filler by weight. Higher binder contents negatively impacted the high-rate discharge characteristics of the battery. Furthermore, the thickness of the porous heat-resistant layer had to be limited to 1-10 um to achieve high discharge rates, and it could not be removed as a free-standing film. Freestanding refers to a sheet having sufficient mechanical properties that manipulation such as winding and unwinding in film can be used during energy storage device assembly.

In US Patent Application Publication No. 2008/0292968 A1 and US Patent Application Publication No. 2009/0111025 A1, an organic/inorganic separator is disclosed in which a porous substrate is coated with a mixture of inorganic particles and a polymer binder to form an active layer on at least one surface of the porous substrate. The porous substrate can be either a non-woven fabric, membrane, or a polyolefin-based separator. Inorganic particles are selected from a group consisting of those that exhibit a dielectric constant greater than 5, piezoelectricity, and/or lithium-ion conductivity. A variety of polymer binders are described. The composite separator is claimed to show excellent thermal safety, dimensional stability, electrochemical safety, and lithium-ion conductivity, compared to uncoated polyolefin-based separators used in lithium batteries. In the case of certain polymer binders mixed with the inorganic particles, a high degree of swelling with electrolyte can result in the surface layer, but rapid wetting or swelling is not achieved in the polyolefin substrate.

In cases where a ceramic composition or slurry is applied to a microporous polymer matrix or polyolefin web and subsequently dried to form a lithium-ion separator with high temperature dimensional stability and improved oxidation resistance while in contact with high voltage cathodes, there is a need to reduce costs through higher throughput and improved yields. In many cases, the rate limiting step involves web handling and drying through either a flotation oven or a conventional hot air oven. Improvements to yield and throughput become even more difficult when only one side of the polyolefin web is first coated, followed by a secondary unwinding and coating step to coat the other (second) surface of the web.

Heretofore, there has been no consideration of combining the benefits from a stenter in which typically a liquid saturated fabric is held under tension in the transverse direction with pins or clips as it traverses a conventional hot air oven with the high velocity air knives used in a flotation oven for drying. In this invention, we have found that such a combination is a cost-effective method for the drying of polyolefin webs to which a ceramic composition or slurry has been applied to both surfaces of the web.

### SUMMARY OF THE INVENTION

An object of the present invention is to achieve thin, freestanding, microporous polyolefin membranes with good oxidation resistance and high temperature dimensional stability as provided through a porous ceramic layer that has been applied to one or both surfaces of the web or polymer matrix. “Freestanding” refers to a web or membrane having sufficient mechanical properties for use in unwinding, coating, winding, slitting and other web handling operations. The terms “film,” “sheet,” “substrate,” “web,” and “membrane” can be used interchangeably, and the term membrane can be used to encompass webs, films, substrates, and sheets.

There are a wide variety of drying and curing ovens that are commonly used in the coating and roll-to-roll processing of plastic film, paper, or foils. Such ovens can include roll support or belt/conveyor support for single-side coating of such substrates. In the case of double-side coating, the web cannot touch a support roller prior to being fully dry. This is where flotation ovens have been best utilized, particularly with the double side, ceramic slurry coating of microporous polyolefin webs for application as a separator in a lithium battery.

A side-view of an open flotation oven is shown in FIG. 1 (depicting an exemplary flotation oven with staggered air knives 10). In using such an oven, the double side coated plastic film, paper, or foil is expected to follow a sinusoidal pattern established by the air knives while traversing the oven. Simultaneously, the liquid carrier (e.g., water or organic solvent) from the coating solution is evaporated and removed from the surface of the plastic film, paper, or foil. An advantage of the flotation oven is the ability to adjust the air velocity and air knife geometry such that rapid drying can be achieved. In the case of a porous material such as paper, there are also capillary forces exerted within the pores that cause stress and shrinkage during the drying process.

In the case of microporous polyolefin webs, special precautions must be taken because of its thickness (<20-25 um) and porosity which lead to a lower modulus (i.e., stiffness) compared to conventional PET films (˜100 um) that are commonly coated and dried in such ovens. Furthermore, the distance between the top of the air knife and the microporous polyolefin web traveling through the oven, and the associated air velocity, need to be re-established for each different thickness of not only the web, but of the applied thickness of the coating solution in its wet state (“wet” thickness).

An additional challenge with flotation ovens are edge effects that result from “baggy edges” in the master roll of the microporous polyolefin web as it is unwound and passed through the coating station prior to entrance into the flotation oven. Even without the application of a coating, “baggy edges” make it difficult to establish a uniform sinusoidal pattern from the air knives. This effect is exacerbated once the coating solution is applied and defects are created if the coated web touches an air knife leaving behind a ceramic deposit and uncoated area on the web. The coated edges may also curl because of non-uniform deposition of the coating solution at the edges.

The edge effects and other potential defects become even more prevalent as the thin, microporous polyolefin web gets wider. This is because the propensity for forming creases in the machine direction increases. As such, most flotation ovens used for producing ceramic-coated polyolefin separators do not exceed 1.2 meters in width.

In order to overcome the above challenges, ENTEK has combined a flotation oven design with a stenter approach used in the fabric industry. In the stenter approach, a saturated fabric is held with pins (needles) or clips in the transverse direction while the material traverses a hot air oven in which convection is used for drying. A schematic view of an exemplary stenter is shown in FIG. 2 (depicting fabric (to which chemicals have been applied) held in a transverse direction via pins or needle chains as it passes through the oven or dryer).

The present invention is a microporous, freestanding heat resistant polyolefin membrane that has resulted from a ceramic composition or slurry applied to one or both major surfaces, followed by drying with air knives impinging upon the membrane while it is simultaneously restrained in the transverse direction (as illustrated in FIG. 3). The transverse restraint helps to minimize capillary forces that typically result in shrinkage or pore collapse during evaporation of the solvent.

### BRIEF DESCRIPTION OF THE DRAWINGS

FIG. 1 depicts a schematic view of an exemplary flotation oven.

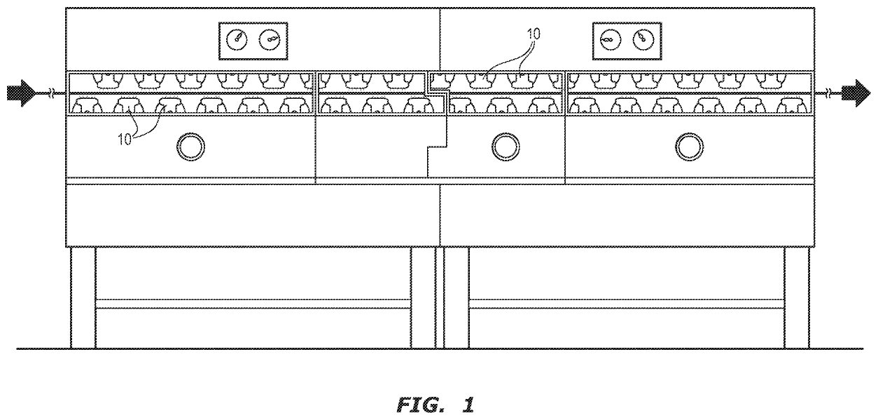

FIG. 2 depicts a schematic view of an exemplary stenter.

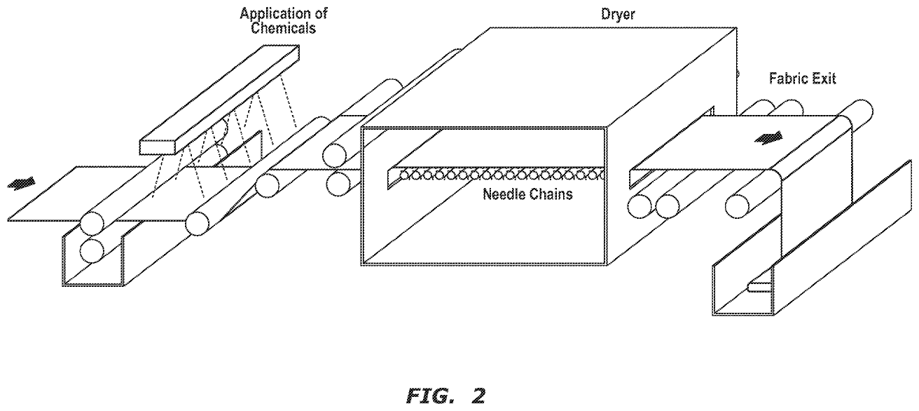

FIG. 3 depicts a schematic view of an exemplary drying oven in accordance with an embodiment of the present disclosure.

### DETAILED DESCRIPTION

The microporous membrane used in this invention is comprised of a polyolefin polymer matrix or bulk structure. The polyolefin most preferably used in the polyolefin matrix is very high molecular weight polyethylene (VHMWPE) with a Mw greater than about 300,000 g/mol (e.g., from about 300,000 to about 3.1 million grams/mol). In some cases, it is desirable to blend the VHMWPE with other polyolefins, such as ultra high molecular weight polyethylene (UHMWPE, Mw greater than about 3.1 to about 10 million grams/mol), high density polyethylene (HDPE) or linear low density polyethylene (LLDPE) in order to impact characteristics such as the shutdown or meltdown properties of the membrane. The microporous membrane generally comprises a porosity from about 35-65%. The pore size range is generally from about 10 nanometers to several microns, with an average pore size of less than about 1 micrometer. The thickness of the membrane (not including the coating) is generally about 3-25 μm, or about 20 μm or less.

The ceramic coating formulation used in this invention comprises inorganic particles dispersed in aqueous mixtures that may contain a small amount of alcohol to improve wetting at the surface of the polyolefin membrane. Exemplary inorganic particles that can be used include inorganic oxides, carbonates, or hydroxides, such as at least one of alumina, silica, zirconia, titania, mica, boehmite, magnesium hydroxide, calcium carbonate, another suitable inorganic acid, or mixtures thereof. One or more hydrotalcites can also be used either alone or in combination with another type of inorganic particle. The inorganic particles are typically charge stabilized and stay suspended in the aqueous mixture. A low molecular weight, water-soluble polymer or polymer dispersion is typically used as a binder for the inorganic particles. It is desirable to choose a polymer with numerous hydrogen bonding sites in order to minimize the binder concentration, yet achieve a robust, microporous surface film that does not easily shed inorganic particles. Acrylates, polyvinyl pyrrolidone, polyvinyl alcohol, carboxy methyl cellulose, and their copolymers or derivatives are representative of preferred polymer binders such that less than or equal to 10 parts polymer binder can be used with 90 parts or more of the inorganic particles.

In another embodiment, an adhesive layer comprising an acrylate or polyvinylidene fluoride (PVDF) copolymer can be disposed on the ceramic layer to form a four or five layer structure. As will be appreciated a four layer structure can include a polyolefin layer coated on one major surface with a ceramic layer, followed by coating each major surface of the polyolefin/ceramic structure with an adhesive layer. A five layer structure can include a polyolefin layer coated on both major surfaces with a ceramic layer, followed by coating each major surface of the ceramic layer with an adhesive layer. In another embodiment, the acrylate or polyvinylidene fluoride (PVDF) copolymer can be combined with inorganic particles such that the double side coated separator can be subsequently adhered to a battery electrode under heat and pressure.

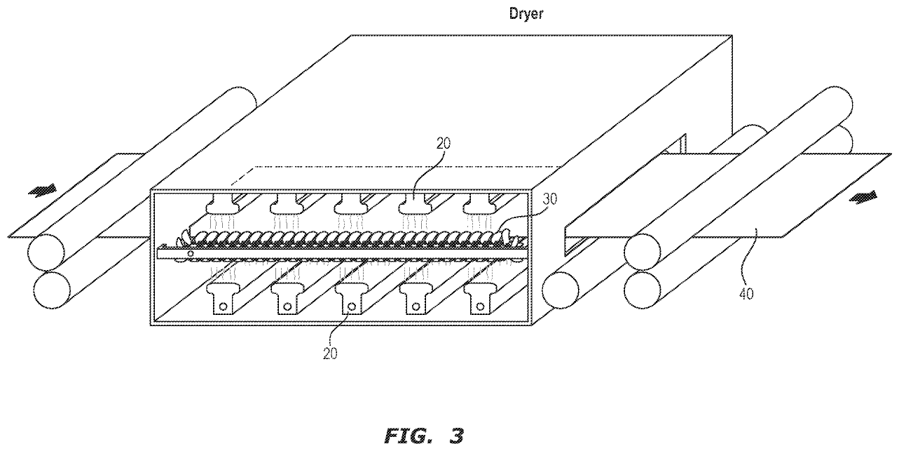

In addition to controlling the amount of polymer binder and inorganic particles in the ceramic coating formulation, we have found that it is important to control the particle size distribution of the inorganic particles. Furthermore, the coating formulation must be carefully applied to the polyolefin web in order to control the thickness of the resultant surface layer. Coating approaches include dip-coating, microgravure, gravure, spray, slot-die, and other processes that can achieve the correct “wet” thickness prior to drying. The preferred drying method utilizes air knives 20 in combination with a pin or clip system 30 that holds the web 40 and keeps it taught in the transverse direction as the web moves through the oven and is then subsequently wound into rolls, as shown in FIG. 3. The air knives 20 can be aligned (as shown in FIG. 3), or they can be staggered. With such a drying system, the width of the polyolefin web 40 passing through the dryer or oven can be greater than about 1.2 m (e.g., such as from about 1.2 m to about 2.4 m or greater). The temperature of the dryer or oven can be from about 60° C. to about 135° C., from about 80° C. to about 130° C., or about 125° C. or greater. Upon drying, the coating weight on the membrane can be from about 0.3 g/m² to about 12 g/m², about 1 g/m² to about 8 g/m², or about 4 g/m² to about 6 g/m². The coated membrane can also exhibit a Gurley number from about 30 to about 250 secs/100 cc air, or from about 100 to about 200 secs/100 cc air.

### Example 1

A microporous polyethylene membrane (ENTEK 12 EPH; 12.4 um; 49.6 % porosity; Gurley air permeability=104 secs/100 cc air) was unwound at a controlled tension and passed over a carbon composite roll to a horizontal position at which time a Mayer rod #10 was used to coat the top membrane surface with a 20 wt. % solids aqueous ceramic slurry (97/3 fumed alumina/PVOH) that contained 4 wt % isopropanol to improve wetting. The solution coated the full width of the sheet except for the outer ˜40 mm on each side which were then held within clips on a chain system. The chains holding each side of the web were parallel for the full distance of the oven which had air knives staggered top and bottom at a distance of ˜100 mm from each surface of the polyethylene membrane. The wetted membrane travelled through the oven at 20 m/min while the oven temperature was 125 C in the plenum that feeds the air knives.

A coat weight of ˜1.1 g/m² was determined for the single side ceramic-coated membrane. The thickness was ˜14.4 um and the air permeability was determined to be 96 secs/100 cc air, which was unexpectedly lower than the uncoated polyethylene membrane.

### Example 2

A microporous polyethylene membrane (ENTEK 12 EPH; 12.4 um; 49.6 % porosity; Gurley air permeability=104 secs/100 cc air) was unwound at a controlled tension and passed over a carbon composite roll to a horizontal position at which time a Mayer rod #10 was used to coat the top membrane surface with a 20 wt. % solids aqueous ceramic slurry (97/3 fumed alumina/PVOH) that contained 4 wt % isopropanol to improve wetting. The solution coated the full width of the sheet except for the outer ˜40 mm on each side which were then held within clips on a chain system. The chains holding each side of the web were parallel for the full distance of the oven which had air knives staggered top and bottom at a distance of ˜100 mm from each surface of the polyethylene membrane. The wetted membrane travelled through the oven at 20 m/min while the oven temperature was 135 C in the plenum that feeds the air knives.

Even at this higher dryer temperature, near the peak melting point of polyethylene, the single side ceramic-coated membrane had a coat weight of 1.25 g/m² and a Gurley value of 96 secs/100 cc air.

It will be understood that reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Recitation in the claims of the term “first” with respect to a feature or element does not necessarily imply the existence of a second or additional such feature or element.

References to approximations are made throughout this specification, such as by use of the term “about.” For each such reference, it is to be understood that, in some embodiments, the value, feature, or characteristic may be specified without approximation. For example, where the qualifier such as “about” is used, this term includes within its scope the qualified words in the absence of its qualifier. For example, where the term “about” is recited with respect to a feature, it is understood that in further embodiments, the feature can have a precise configuration. Unless otherwise stated, all ranges include both endpoints and all numbers between the endpoints.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

1. A freestanding, microporous membrane, comprising:
a polymer matrix extending from one surface to an opposite surface, the polymer matrix including a polyolefin having a molecular weight of 300,000 g/mol or greater; and
a porous ceramic coating disposed on at least one side of the polymer matrix, wherein the microporous membrane was formed in a continuous process in which the ceramic coating was dried while the polymer matrix was restrained in a transverse direction at elevated temperature.

2. The microporous membrane of claim 1, wherein the polymer matrix includes a blend of a very high molecular weight polyethylene (VHMWPE) and at least one of ultra-high molecular weight polyethylene (UHMWPE), high density polyethylene (HDPE), or linear low density polyethylene (LLDPE).

3. The microporous membrane of claim 1, wherein the polymer matrix comprises a thickness of about 20 μm or less.

4. The microporous membrane of claim 1, wherein the polymer matrix comprises a width of about 1.2 m or greater.

5. The microporous membrane of claim 1, wherein the porous ceramic coating is disposed on two opposing sides of the polymer matrix.

6. The microporous membrane of claim 1, wherein the membrane has a coating weight of about 0.3 to about 12 g/m², about 1 to about 8 g/m², or about 4 to about 6 g/m².

7. The microporous membrane of claim 1, wherein the membrane exhibits a Gurley number of about 30 to about 250 secs/100 cc air, or about 100 to about 200 secs/100 cc air.

8. The microporous membrane of claim 1, for use as a ceramic-modified separator in a lithium ion or rechargeable Li metal battery.

9. A method of making a freestanding, microporous membrane, the method comprising:
restraining a polymer matrix in a transverse direction thereof, the polymer matrix including a polyolefin having a molecular weight of 300,000 g/mol or greater;
coating at least a portion of at least one side of the polymer matrix with a ceramic coating; and
exposing the polymer matrix and the ceramic coating to elevated temperatures.

10. The method of claim 9, wherein restraining the polymer matrix includes restraining the polymer matrix with pins or clips.

11. The method of claim 9, wherein exposing the polymer matrix and the ceramic coating to elevated temperatures includes exposing the polymer matrix and the ceramic coating to temperatures of about 125° C. or greater.

12. The method of claim 9, wherein exposing the polymer matrix and the ceramic coating to elevated temperatures includes disposing the polymer matrix and the ceramic coating in a drying oven.

13. The method of claim 9, wherein the polymer matrix comprises a thickness of about 20 μm or less.

14. The method of claim 9, wherein the polymer matrix comprises a width of about 1.2 m or greater.

15. The method of claim 9, wherein the polymer matrix includes a blend of a very high molecular weight polyethylene (VHMWPE) and at least one of ultra-high molecular weight polyethylene (UHMWPE), high density polyethylene (HDPE), or linear low density polyethylene (LLDPE).

16. The method of claim 9, wherein the ceramic coating is on two opposing sides of the polymer matrix.

17. The method of claim 9 ,wherein the membrane has a coating weight of about 0.3 to about 12 g/m², about 1 to about 8 g/m², or about 4 to about 6 g/m².

18. The method of claim 9, wherein the membrane exhibits a Gurley number of about 30 to about 250 secs/100 cc air, or about 100 to about 200 secs/100 cc air.

19. A freestanding, microporous membrane formed according to the method of claim 9.

20. A drying oven comprising:
an inlet;
an outlet downstream from the inlet;
a passageway extending between the inlet and the outlet;
a plurality of air knives positioned in the passageway; and
a plurality of restraining elements configured to restrain a polyolefin web in a transverse direction thereof as the polyolefin web moves from the inlet to the outlet.
